(19) United States
(12) Patent Application Publication
(10) Pub. No.: US 2023/0413738 A1
(43) Pub. Date: Dec. 28, 2023

(54) PLANT FACTORY LIGHTING SYSTEM

(71) Applicant: ODYSSEYGLOBAL CO., LTD., Gwangju (KR)

(72) Inventor: Jong Hyun JEONG, Gwangju (KR)

(73) Assignee: ODYSSEYGLOBAL CO., LTD., Gwangju (KR)

(21) Appl. No.: 18/461,025

(22) Filed: Sep. 5, 2023

Related U.S. Application Data
(63) Continuation of application No. PCT/KR2021/013314, filed on Sep. 29, 2021.

(30) Foreign Application Priority Data
May 17, 2021 (KR) 10-2021-0063676

(51) Int. Cl. A01G 7/04; A01G 9/24; F21V 29/56

(52) U.S. Cl. CPC A01G 7/045; A01G 9/249; F21V 29/56; F21Y 2115/10

(57) ABSTRACT

The present disclosure relates to a plant factory lighting system that includes at least: LED groups; a first switch that receives a first operation signal; a second switch unit that has a lever and a toggle switch formed such that that the lever is set one of a plurality of setting positions or a neutral position by operation of a worker and a signal generator generating a second operation signal such that the LED groups are operated in different operation patterns in accordance with the position of the lever; and a control module that controls operation of the LED groups to correspond to the first operation signal when the lever of the toggle switch is set at the neutral position, and controls operation of the LED groups to correspond to the second operation signal when the lever of the toggle switch is set at the setting positions.

### CROSS REFERENCE TO RELATED APPLICATION

This application is a Continuation of International

Application No. PCT/KR2021/013314 filed on Sep. 29, 2021, which claims the priority of Korean Patent Application No. 10-2021-0063676 filed on May 17, 2021, in the Korean Intellectual Property Office, the disclosure of which is incorporated herein by reference.

### BACKGROUND OF THE INVENTION

### Field of the Invention

The present disclosure relates to a plant factory lighting system, that is, a plant factory lighting system that can control LED groups, which output light of different wavelengths, through a toggle switch and an on/off power touch pad.

### Description of the Related Art

In general, the sunlight or incandescent electric lamps and high-voltage sodium lamps, which are artificial lighting, were used for lighting that is required for growth of crops, but, recently, using semiconductor light emission diodes for plant cultivation results in considerable economic effect in cultivation of crops.

Recently, as shown in FIG. 1, a rearing system for plant growth that uses light emission diodes for plant cultivation has been published, and as a similar document, there is a document about a configuration in which one kind or two or more kinds of LEDs of several kinds of LEDs, which emit light of an optimal wavelength in accordance with the kinds and the growth process of plants, are disposed at an appropriate ratio on a boards such that they can be replaced in accordance with the kinds and the growth state of plants.

Further, there is also a document about construction of a plant cultivation system using wavelengths of 730 nm, 660 nm, and 450 nm as a closed-type LED plant factory so that pigment plants can be cultivated with high production efficiency within a short period in a narrow space.

Substantially, as in FIG. 2, users purchase three LED lamps of different wavelength and then replace the LED lights in accordance with the growth cycles of plants in a plant factory. Further, as in FIG. 3, users also periodically replace five LED lights of different wavelengths.

However, since several LEDs are controlled by a single switch device in LED lighting devices of the related art, it is difficult for workers to quickly cope with more various situations, there is an economic load that it is required to purchase and install several kinds of LED lighting devices, and particularly, in Korea, all of LED lighting devices have to be imported, so it results in hindrance in commercialization of a smart farm that is a core of the 4th industry.

[Prior Art Document]

[Patent Document]

Korean Patent No. 10-0902071: LED lamp using cultivation method and the device plants.

### SUMMARY OF THE INVENTION

The present disclosure has been made in an effort to solve the problems described above and an objective of the present disclosure is to provide a plant factory lighting system that can operate many LED groups in accordance with a predetermined operation pattern using a toggle switch and an on/off power touch pad.

In order to achieve the objectives of the present disclosure, an plant factory lighting system includes: a substrate; a lighting unit that is mounted on the substrate and includes many LED groups generating light of different wavebands; a first switch that enables a worker to input a first operation signal for operation of the LED groups through a touch for operation; a second switch unit that has a lever to be able to be operated by the worker, and includes a toggle switch formed such that that the lever is set any one position of a plurality of setting positions or a neutral position by operation of the worker and a signal generator generating a second operation signal such that the LED groups are operated in different operation patterns in accordance with the position of the lever set by the worker; and a control module that controls the lighting unit in accordance with the first operation signal or the second operation signal, controls operation of the LED groups to correspond to a first operation signal that is provided from the first switch unit when the lever of the toggle switch is set at the neutral position, and controls operation of the LED groups to correspond to a second signal that is provided from the second switch unit when the lever of the toggle switch is set at the setting positions.

The first switch unit includes: an on/off power touch pad that the worker can touch for operation; a pattern storage storing many light emission patterns about operation of the LED groups; and a pattern setter that generates the first operation signal that the LED groups are operated in any one of the light emission patterns stored in the storage, and generates the first operation signal such that light emission patterns, which are applied to the LED groups of the light emission patterns, are sequentially changed in accordance with a preset operation order when a touch by the worker is input on the on/off power touch pad.

The lighting unit is manufactured by doping UV-a LED and BLU LED chips with phosphor to emit light of many wavebands.

The lighting unit includes: a first LED group that emits light having a center waveband of 380 nm by 25% to 35% of the entire photon quantity, emits light of a waveband of 380 nm to 450 nm by 5% to 15% of the entire photon quantity, and emits light of a waveband of 600 nm to 700 nm by the other of the entire photon quantity; a second LED group that emits light having a center waveband of 380 nm by 15% to 25% of the entire photon quantity, emits light of a waveband of 380 nm to 500 nm by 15% to 25% of the entire photon quantity, and emits light of a waveband of 600 nm to 800 nm by the other of the entire photon quantity; and a third LED group that emits light of a waveband of 600 nm to 700 nm by 60% to 70% of the entire photon quantity.

The substrate is installed in an internal space of a plant cultivation device in which many plants are grown, and the plant factory lighting system further includes: a measurement sensor installed on the substrate and measuring concentration of oxygen or carbon dioxide in the internal space; a determination module determining a growth state of plants that are grown in the internal space on the basis of information measured by the measurement sensor; and a recommendation unit providing the worker with information about the waveband of light corresponding to a growth state of plants on the basis of determination information provided from the determination module.

The substrate is installed at a supply pipe provided in an internal space of a plant cultivation device to be able to supply growing water to plants that are grown in the internal space; and the plant factory lighting system further includes a heat dissipation unit provided at the substrate to be able to dissipation heat, which is generated at the lighting unit, to growing water flowing through the supply pipe so that the lighting unit can be cooled.

The heat dissipation unit includes: at least one heat dissipation fin that is installed on the substrate facing the supply pipe and protruding toward the supply pipe so that heat transferring through the substrate transfers; and a heat dissipation member that is formed at the supply pipe facing the substrate such that an end is inserted in an internal channel of the supply pipe, through which the growing water flows, and has a insertion hole such that the heat dissipation fin can be inserted, and the insertion hole is formed with a predetermined depth in the supply pipe from an outer surface of the heat dissipation member, which faces the substrate, such that the heat dissipation fin can be inserted in the supply pipe.

The heat dissipation member has a plurality of extensions extending in a front-rear direction with reference to a flow direction of growing water in the internal channel, and the extensions are formed such that front ends are in contact with each other, rear ends are spaced apart from each other, and a spaced distance increases toward a rear from a front end to be able to reduce interference with flow of growing water passing through the supply pipe.

Meanwhile, the plant factory lighting system according to the present disclosure may further include: a circulator that is installed at the supply pipe to be able to circulate growing water remaining in the supply pipe when the growing water is not supplied to the plants; a temperature sensor that is installed in the supply pipe at a position adjacent to the heat dissipation member to be able to measure temperature of growing water around the heat dissipation member; and a circulation controller that operates the circulator to be able to circulate the growing water remaining in the supply pipe when temperature of growing water around the heat dissipation member is over a preset limit temperature on the basis of measurement information that is provided from temperature sensor.

The plant factory lighting system according to the present disclosure can easily operate many LED groups in accordance with many operation patterns using the toggle switch and the on/off power touch pad, so there is an advantage that it is possible to quickly take measures against various situations according to growth of plants.

### BRIEF DESCRIPTION OF THE DRAWINGS

FIG. 1 is a picture of a rearing system for plant growth of the related art;

FIGS. 2 and 3 are exemplary views of LED lights that are used in a rearing system for plant growth of the related art;

FIG. 4 is a view showing a substrate of a plant factory lighting system according to the present disclosure;

FIG. 5 is a conceptual view of the plant factory lighting system of FIG. 1;

FIG. 6 is a block diagram of the plant factory lighting system of FIG. 1;

FIG. 7 is a waveband curve graph showing of an LED group obtained by doping UV-a LED chips with phosphor;

FIG. 8 is a waveband curve graph of an LED group obtained by doping BLU diode chips with phosphor;

FIG. 9 is a waveband curve graph when an LED group obtained by doping UV-a LED chips with phosphor and an LED group obtained by doping BLU LED chips with phosphor are simultaneously operated;

FIG. 10 is a cross-sectional view of a plant factory lighting system according to another embodiment of the present disclosure;

FIG. 11 is a partial cross-sectional view of the plant factory lighting system of FIG. 7;

FIG. 12 is a perspective view of a heat dissipation member a plant factory lighting system according to another embodiment of the present disclosure; and

FIG. 13 is a conceptual view of a plant factory lighting system according to another embodiment of the present disclosure.

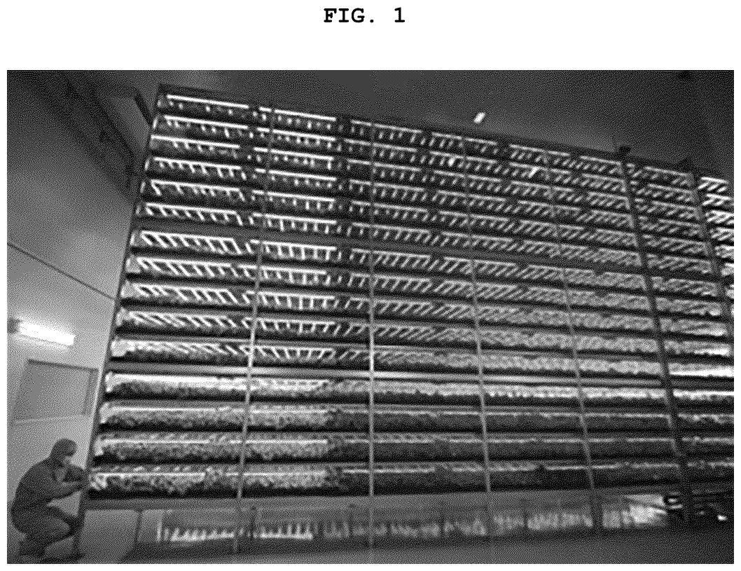

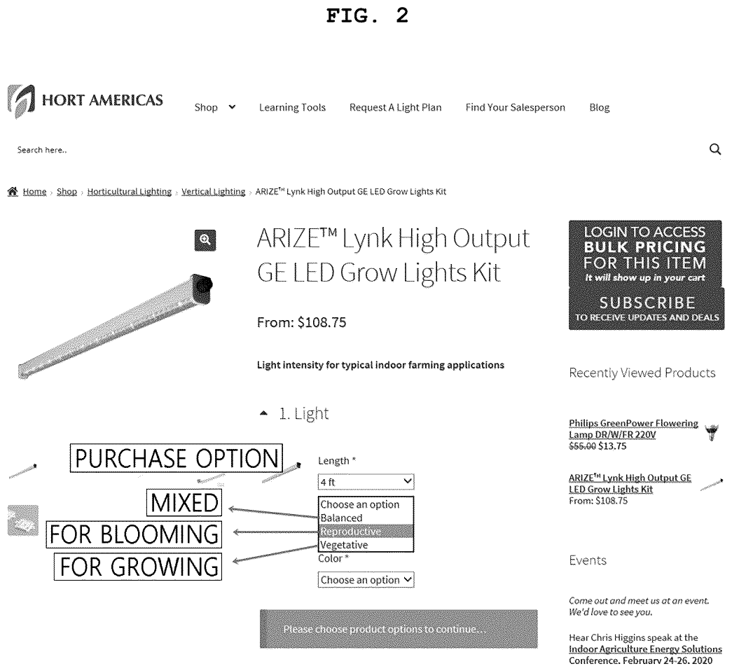

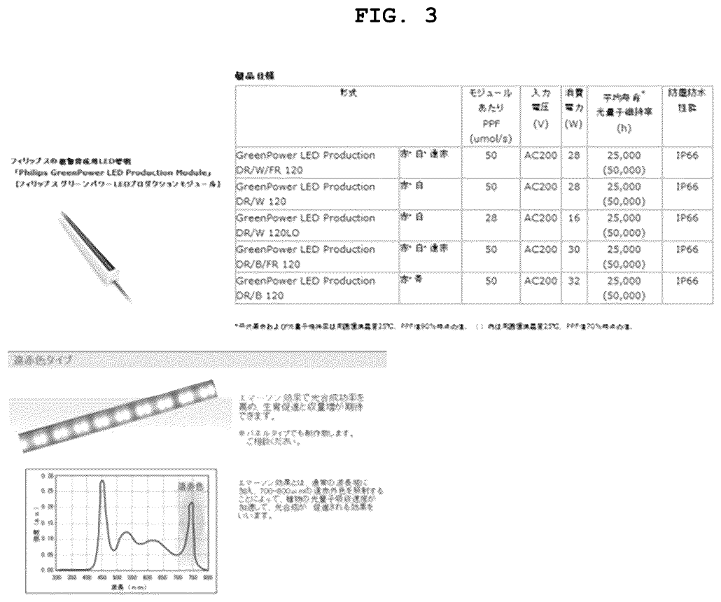

### DETAILED DESCRIPTION OF THE INVENTION

Hereafter, a plant factory lighting system according to an embodiment of the present disclosure is described in detail with reference to the accompanying drawings. The present disclosure may be modified in various ways and implemented by various exemplary embodiments, so that specific exemplary embodiments are shown in the drawings and will be described in detail herein. However, it is to be understood that the present disclosure is not limited to the specific exemplary embodiments, but includes all modifications, equivalents, and substitutions included in the spirit and the scope of the present disclosure. Similar reference numerals are assigned to similar components in the following description of drawings. In the accompanying drawings, the dimensions of structures were exaggerated larger than the actual dimensions to make the present disclosure clear.

Terms used in the specification, “first”, “second”, etc., may be used to describe various components, but the components are not to be construed as being limited to the terms. The terms are used only to distinguish one component from another component. For example, the “first” component may be named the “second” component, and vice versa, without departing from the scope of the present disclosure.

The terminologies used herein are used for the purpose of describing particular embodiments and are not intended to limit the present disclosure. Singular forms are intended to include plural forms unless the context clearly indicates otherwise. It will be further understood that the terms “comprises” or “have” used in this specification specify the presence of stated features, steps, operations, components, parts, or a combination thereof, but do not preclude the presence or addition of one or more other features, numerals, steps, operations, components, parts, or a combination thereof.

Unless defined otherwise, it is to be understood that all the terms used in the specification including technical and scientific terms has the same meaning as those that are understood by those who skilled in the art. It will be further understood that terms such as terms defined in common dictionaries should be interpreted as having a meaning that is consistent with their meaning in the context of this specification and the relevant art and will not be interpreted in an idealized or overly formal sense unless expressly so defined herein.

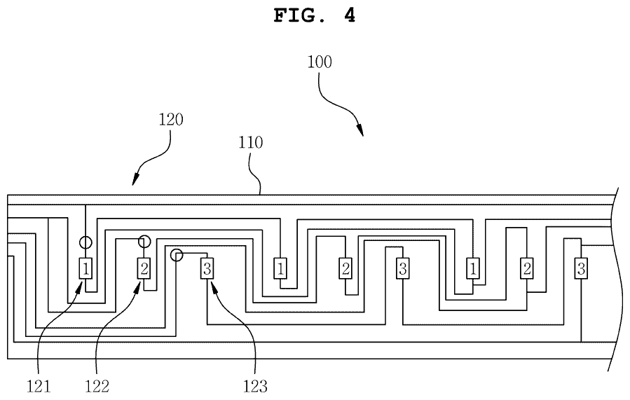

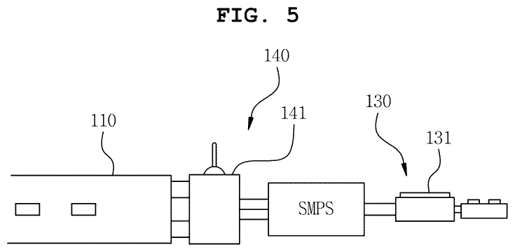

A plant factory lighting system 100 according to the present disclosure are shown in FIGS. 4 to 6.

Referring to the figures, the plant factory lighting system 100 includes a substrate 110, a lighting unit 120 mounted on the substrate 110 and having many LED groups generating light of different wavelengths, a first switch unit 130 enabling a worker to input a first operation signal about the operation of the LED groups by touching, a second switch unit 140 through which a second operation signal about operation of the LED groups can be input by operation of a toggle switch 141, and a control module 150 controlling the lighting unit 120 in accordance with operation signals that are provided from the first and second switch unit 140.

The substrate 110 is formed in a plate shape having a predetermined thickness and extends a predetermined length in the front-rear direction. The substrate 110 is a PCB substrate 110 that is generally used in the related art to mount light emission diodes such as LEDs, so it is not described in detail. Further, a perforated line may be formed in the width direction on the substrate 110 so that a worker can cut and use the substrate 110 using a cutting tool such as scissors or a knife. The substrate 110 is installed in an internal space of a plant cultivation device 10 in which many plants are grown. In this case, it is preferable that the substrate 110 is installed on the ceiling of the plant cultivation device 10 that faces plants.

The lighting unit includes first to third LED groups 121, 122, and 123 that are mounted on the substrate 110 and output light of different wavelengths.

The first LED group 121 includes many first light emission diodes mounted to be spaced apart from each other in the longitudinal direction on the substrate 110. The first light emission diodes emit light of three kinds of different wavebands.

The light of the first waveband of the first light emission diodes is light having a center waveband of 380 nm and is emitted by 25% to 35% of the entire photon quantity of the first light emission diodes. The shape of the emission waveband of the light of the first wavelength of the first light emission diodes has a gentle bell-shaped curved shape around the center waveband.

The light of the second waveband of the first light emission diodes has a center waveband of 400 nm and a wavelength bandwidth of 380 nm to 450 nm, and is emitted by 5% to 15% of the entire photon quantity of the first light emission diodes. The shape of the emission waveband of the light of the second waveband of the first light emission diodes has a gentle bell-shaped curved shape around the center waveband.

The light of the third waveband emitting the other of the entire photon quantity of the first light emission diodes has a center waveband of 670 nm and a waveband width of 600 nm to 700 nm. The shape of the emission waveband of the light of the second waveband of the first light emission diodes has a gentle bell-shaped curved shape around the center waveband.

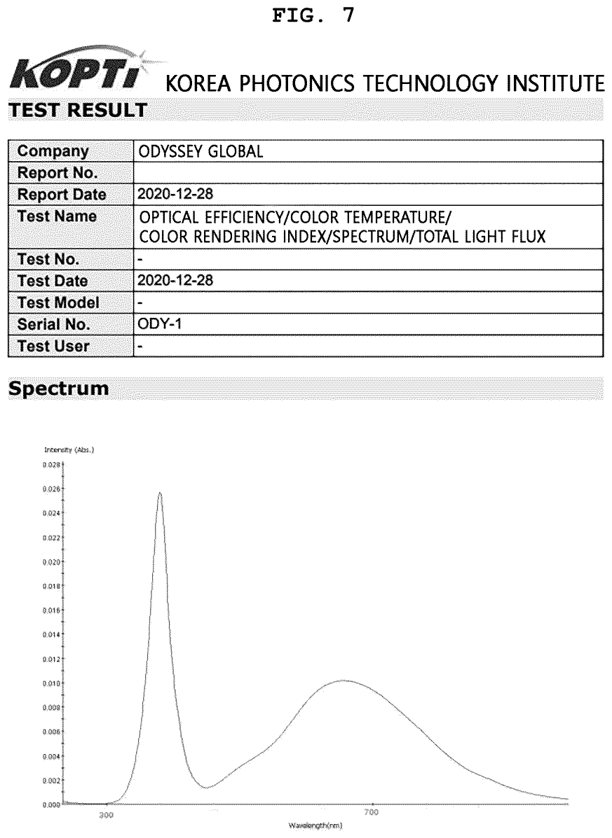

In this case, the first light emission diode is manufactured by doping LED chips, which output UV-a, with phosphor to be able to emit the light. A spectrum analysis result on the first light emission diodes is shown in FIG. 7.

The second LED group 122 includes many second light emission diodes mounted to be spaced apart from each other in the longitudinal direction on the substrate 110. The second light emission diodes emit light of three kinds of different wavebands.

The light of the first waveband of the second light emission diodes is light having a center waveband of 380 nm and is emitted by 15% to 25% of the entire photon quantity of the second light emission diodes. The shape of the emission waveband of the light of the second wavelength of the first light emission diodes has a gentle bell-shaped curved shape around the center waveband.

The light of the second waveband of the second light emission diodes has a center waveband of 430 nm and a waveband width of 380 nm to 500 nm, and is emitted by 15% to 25% of the entire photon quantity of the second light emission diodes. The shape of the emission waveband of the light of the second waveband of the second light emission diodes has a gentle bell-shaped curved shape around the center waveband.

The light of the third waveband emitting the other of the entire photon quantity of the first light emission diodes has a center waveband of 730 nm and a waveband width of 600 nm to 800 nm. The shape of the emission waveband of the light of the third wavelength of the second light emission diodes has a gentle bell-shaped curved shape around the center waveband.

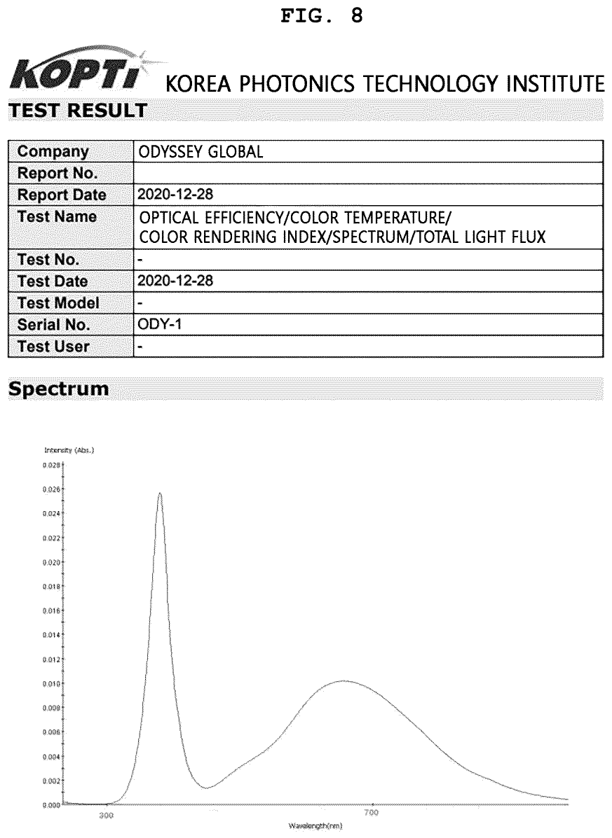

In this case, the second light emission diode is manufactured by doping LED chips, which output UV-a, with nitride-based phosphor and curing nitride-based phosphor and then doping them with a YAG-series phosphor to be able to emit the light. A waveband curve graph of an LED group obtained by doping UV-a LED chips with phosphor is shown in FIG. 8.

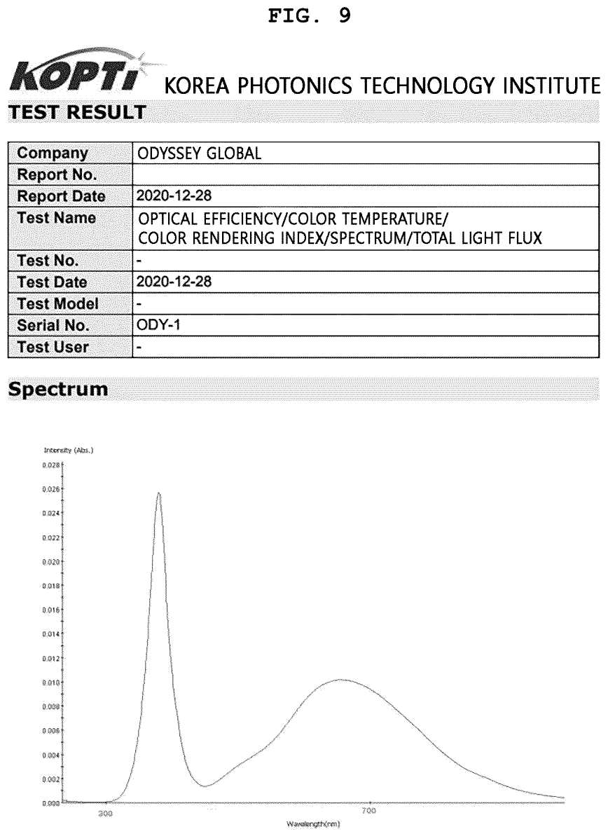

The third LED group 123 includes many third light emission diodes mounted to be spaced apart from each other in the longitudinal direction on the substrate 110. The third light emission diodes are formed such that light having a waveband of 600 nm to 700 nm is emitted by 60% to 70% of the entire photon quantity. The third light emission diode is formed by doping BLU diode chips, which emit a waveband of 430 nm, with nitride-based phosphor such that the center waveband is 660 nm and the wavelength range is 600 nm to 700 nm. A waveband curve graph of an LED group obtained by doping BLU diode chips with phosphor is shown in FIG. 9.

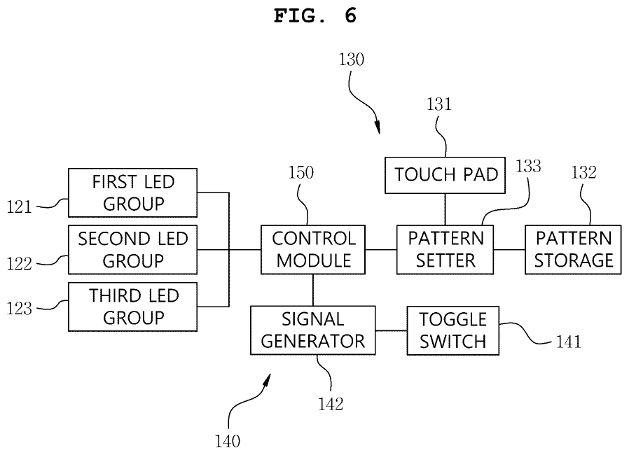

Meanwhile, according to the lighting unit 120, the LED group obtained by doping UV-a LED chips with phosphor and an LED group obtained by doping BLU LED chips with phosphor can be simultaneously operated, and a waveband curve graph when the two LED groups are simultaneously operated is shown in FIG. 6.

In this case, it is preferable that the first to third light emission diodes are sequentially and alternately installed along a longitudinal center line of the substrate 110. In this case, the lighting unit 120 composed of the first to third light emission diodes constitutes one unit light, and many lighting units 120 may be disposed in a direct connection type on the substrate 110. In this case, the first to third light emission diodes are each directly connected and independently grounded, it is possible to cut the substrate 110 along perforated lines (not shown) between the lighting unit 120, and the first to third light emission diodes each can maintain direct connection even though the substrate 110 is cut.

The lighting unit 120 is operated by power that is supplied from a power supplier. In this case, a power supply unit that is generally used in the related art to supply power to LED groups is applied to the power supplier, so the power supplier is not described in detail.

The first switch unit 130, which can input a first operation signal for operation of the LED groups in response to a touch for operation by a worker, includes an on/off power touch pad 131, a pattern storage 132, and a pattern setter 133.

The on/off power touch pad 131, which a worker can touch for operation, is disposed at a position adjacent to the lighting unit 120. The on/off power touch pad 131 is a recognizing unit such as touch screen that is generally used in the related art to recognize a finger touch by a worker, so it is not described in detail.

Many light emission patterns about operation of the LED groups of the lighting unit 120 are stored in the pattern storage 132. The light emission pattern includes a light emission pattern in which the first LED group 121 is independently operated, a light emission pattern in which the second LED group 122 is independently operated, a light emission pattern in which the third LED group 123 is independently operated, a light emission pattern in which the first and second LED groups 121 and 122 are operated, a light emission pattern in which the first and third LED groups 121 and 123 are operated, a light emission pattern in which the second and third LED groups 122 and 123 are operated, a light emission pattern in which the first to third LED groups 121, 122, and 123 are operated, etc.

The pattern setter 133 generates and transmits a first operation signal such that the LED groups of the lighting unit 120 are operated in any one of the light emission patterns stored in the pattern storage 132. In this case, the pattern setter 133 generates a first operation signal such that light emission patterns that are applied to the LED groups of the light emission patterns are sequentially changed in accordance with a preset operation order when a touch by a worker is input on the on/off power touch pad 131. For example, the pattern setter 133 generates a first operation signal corresponding to the light emission pattern in which the first LEG groups 121 is independently operated and the light emission pattern in which the second LED group 122 is independently operated when a touch by a worker is recognized first on the on/off power touch pad 131; and generates a first operation signal corresponding to the light emission pattern in which the second LED group 122 is independently operated when a touch by a worker is recognized again on the on/off power touch pad 131. Further, the pattern setter generates a first operation signal corresponding to the light emission pattern in which the third LED group 123 is independently operated when a touch by a worker is recognized again on the on/off power touch pad 131, and generates a first operation signal corresponding to the light emission pattern in which the first and second LED groups 121 and 122 are operated when a touch by a worker is recognized again on the on/off power touch pad 131. Further, the pattern setter generates a first operation signal corresponding to the light emission pattern in which the first and third LED group 121 and 123 are operated when a touch by a worker is recognized again on the on/off power touch pad 131, and generates a first operation signal corresponding to the light emission pattern in which the second and third LED groups 122 and 123 are operated when a touch by a worker is recognized again on the on/off power touch pad 131. Further, the pattern setter generates a first operation signal corresponding to the light emission pattern in which the first to third LED group 121, 122, and 123 are operated when a touch by a worker is recognized again on the on/off power touch pad 131, and generates a first operation signal corresponding to the light emission pattern in which the first LED group 121 is operated when a touch by a worker is recognized again on the on/off power touch pad 131.

In this case, the operation order of the light emission patterns is not limited thereto, and it is preferable that LED groups having wavebands suitable for growth of plants to be grown are set by an expert and LED groups are sequentially set in accordance with the growth periods of plants. Accordingly, even if a worker is not an expert, it is possible to operate the light emitting unit 120 such that light of wavebands corresponding to the growth states of plants by sequentially touching the on/off power touch pad 131.

The second switch includes a toggle switch 141 and a signal generator 142 that generates a second signal for operation of the lighting unit 120 in accordance with operation of the toggle switch 141.

The toggle switch 141 has a lever enabling the worker to operate the toggle switch, and the lever is formed to be set at any one position of a plurality of setting positions or a neutral position by operation of the worker. In this case, a toggle switch 141 that is generally used in the related art such that a lever can be positioned at any one position of up, down, and neutral is applied the toggle switch 141, so the toggle switch 141 is not described in detail. In this case, many toggle switches 141 may be provided in accordance with the number of the LED groups of the lighting unit 120.

The signal generator 142 generates a second operation signal such that the LED groups are operated in different operation patterns in accordance with the position of the lever set by a worker. The operation patterns include an operation pattern in which the first LED group 121 is independently operated, an operation pattern in which the second LED group 122 is independently operated, an operation pattern in which the third LED group 123 is independently operated, an operation pattern in which the first and second LED groups 121 and 122 are operated, an operation pattern in which the first and third LED groups 121 and 123 are operated, an operation pattern in which the second and third LED groups 122 and 123 are operated, an operation pattern in which the first to third LED groups 121, 122, and 123 are operated, etc.

For example, the signal generator 142 may generate a second operation signal corresponding to the operation pattern in which the first LED group 121 is independently operated when the lever is set at any one of the setting positions, and may generate a second operation signal corresponding to the operation pattern in which the third LED groups 123 is independently operated when the lever is set at another one of the setting positions. In this case, the operation patterns can be set by a worker.

The control module 150 controls the lighting unit 120 in accordance with a first operation signal or a second operation signal that is provided from the first and second switch units 140. In this case, the control module 150 controls operation of the LED groups to correspond to a first operation signal that is provided from the first switch unit 130 when the lever of the toggle switch 141 is set at the neutral position. Further, the control module 150 controls operation of the LED groups to correspond to a second operation signal that is provided from the second switch unit 140 when the lever of the toggle switch 141 is set at the setting positions.

That is, when the lever of the toggle switch 141 is set at the neutral position, a worker can sequentially change the light emission patterns of the lighting unit 120 using the on/off power touch pad 131 in accordance with a preset operation order, and when the lever of the toggle switch 141 is set at setting positions excluding the neutral position, the control module 150 controls the lighting unit 120 such that the LED groups set at the setting positions are operated.

As described above, a worker can control the lighting unit 120 selectively through the on/off power touch pad 131 or the toggle switch 141. When the lighting unit 120 is controlled using the on/off power touch pad 131, the LED groups are operated in accordance with an operation order set in advance by an expert, so even if a worker is not an expert, it is possible to emit light of a waveband, which is suitable for the growth state of a plant, to the plant. Further, when the lighting unit 120 is controlled through the toggle switch 141, it is possible to change the operation patterns of the LED groups more quickly than controlling by the on/off power touch pad 131. Accordingly, the plant factory lighting system 100 according to the present disclosure can easily operate many LED groups in accordance with many operation patterns using the toggle switch 141 and the on/off power touch pad 131, so there is an advantage that it is possible to quickly take measures against various situations according to the kinds and growth of plants.

Meanwhile, the plant factory lighting system 100 according to the present disclosure may further include, though not shown in the figures, a measurement sensor installed on the substrate 110 and measuring the concentration of oxygen or carbon dioxide in the internal space, a determination module determining the growth state of plans that are grown in the internal space on the basis of information measured by the measurement sensor, and a recommendation module recommending information about the waveband of light corresponding to the growth state of plants to the worker on the basis of determination information provided from the determination module.

The measurement sensor is installed on the bottom of the substrate 110 that faces plants, and measures the concentration of oxygen or carbon dioxide in the internal space of the plant cultivation device 10. The measurement sensor provides a measured concentration value to the determination module.

The determination module calculates the rate of change of the concentration of oxygen or carbon dioxide in the internal space on the basis of information provided from the measurement sensor. Concentration variation of oxygen or carbon dioxide in the internal space depends on growth of plants, and the determination module determines growth information of plants on the basis of differences in variation of the concentration of oxygen or carbon dioxide. In this case, the determination module may determine the growth degree of a plant by applying a calculated rage of change of concentration to a pre-constructed neural network model for determining the growth degree of the plant in accordance with the rate of change of the concentration of oxygen or carbon dioxide in the space in which the plant is grown.

The recommendation module provides a worker with information about the waveband of light corresponding to the growth state of a plant in accordance with determination information that is provided from the determination module. The recommendation module includes a database in which information about the wavebands of light suitable for growth states of plants, and extract waveband information of light, which corresponds to the growth state of a plant in the plant cultivation device 10 determined by the determination module, from the database and provides the waveband information to a worker. In this case, the recommendation module may provide recommendation information through a pre-registered terminal such as a smartphone of a worker.

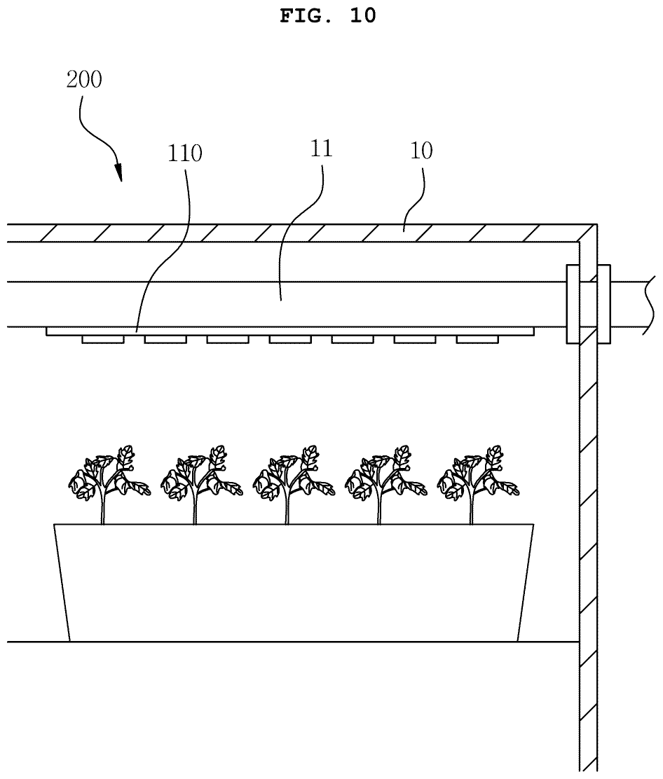

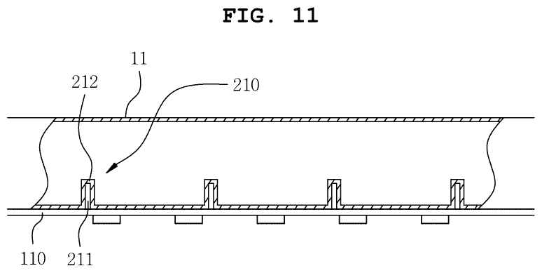

Meanwhile, a plant factory lighting system 200 according to another embodiment of the present disclosure is shown in FIGS. 10 and 11.

The components having the same functions as those in the above figures are given the same reference numerals.

Referring to the figures, according to the plant factory lighting system 200, the substrate 110 is installed on a supply pipe 11 provided in the internal space of the plant cultivation device 10 to be able to supply growing water to the plants that are grown in the internal space. In this case, the plant factory lighting system 200 further includes a heat dissipation unit 210, which is disposed on the substrate 110 to be able to dissipate heat generated by the lighting unit 120 to the growing water flowing through the supply pipe 11, to be able to cool the lighting unit 120.

The plant cultivation device 10 includes a growing water supplier for supplying growing water to plants that are grown in the internal space. The growing water supplier includes a supply pipe 11 installed in the internal space of the plant cultivation device 10, a supply unit (not shown) supplying growing water to the supply pipe 11, and a spray nozzle (not shown) installed at the supply pipe 11 and spraying growing water to the plants in the internal space.

The supply pipe 11 has an internal channel, through which the growing water flow, and is installed in the internal space of the plant cultivation device 10, that is, on the ceiling of the internal space. It is preferable that the supply pipe 11 extends a predetermined length and the substrate 110 is installed on the bottom thereof. The supply unit, though not shown, includes a storage tank storing the growing water, a connection pipe connected to the storage tank and the supply pipe 11, and a sending pump installed at the connection pipe and sending the growing water in the storage tank to the supply pipe 11.

The heat dissipation unit 210 includes: many heat dissipation fins 211 that are installed on the substrate 110 facing the supply pipe 11 so that heat transferring from the substrate 110 transfers, and that protrude toward the supply pipe 11; and heat dissipation members 212 that are formed in the supply pipe 11 facing the substrate 110 such that the ends thereof are inserted in the internal channel of the supply pipe 11 through which the growing water flows, and that have insertion holes such that the heat dissipation fins 211 can be inserted.

The heat dissipation fins 211 protrude a predetermined length upward from the top of the substrate 110 and are arranged to be spaced apart from each other in the longitudinal direction of the substrate 110. It is preferable that the heat dissipation fins 211 are made of a metallic material having high thermal conductivity so that heat transferring from the substrate 110 easily transfers. Meanwhile, a structure having many heat dissipation fins 211 is shown in the example shown in the figures, but the heat dissipation fins 211 are not limited to the example shown in the figures, and one heat dissipation fin may be formed, depending on the size of the plant cultivation device 10 and the length of the supply pipe 11.

The heat dissipation members 212 are formed on the bottom of the supply pipe 11 that faces the heat dissipation fins 211 such that the upper ends thereof are inserted in the internal channel of the supply pipe 11. Further, insertion holes in which the heat dissipation fins 211 are inserted are formed on the bottoms of the heat dissipation members 212. In this case, it is preferable that the insertion holes are formed to be inserted with a predetermined depth in the supply pipe 11, that is, upward from the bottoms of the heat dissipation members 212 that face the substrate 110 so that the heat dissipation fins 211 can be inserted in the supply pipe 11. Meanwhile, the insertion holes are formed in a shape corresponding to the heat dissipation fins 211 such that the outer surfaces of the heat dissipation fins 211 can be in contact with the inner surfaces thereof.

The heat dissipation unit 210 having the configuration described above dissipates heat, which is generated at the substrate 110 through the heat dissipation fins 211 and the heat dissipation members 212, through the growing water flowing through the supply pipe 11, whereby there is an advantage that it is possible to increase the lifespan of the lighting unit 120 by preventing deterioration of the lighting unit 120 of the substrate 110.

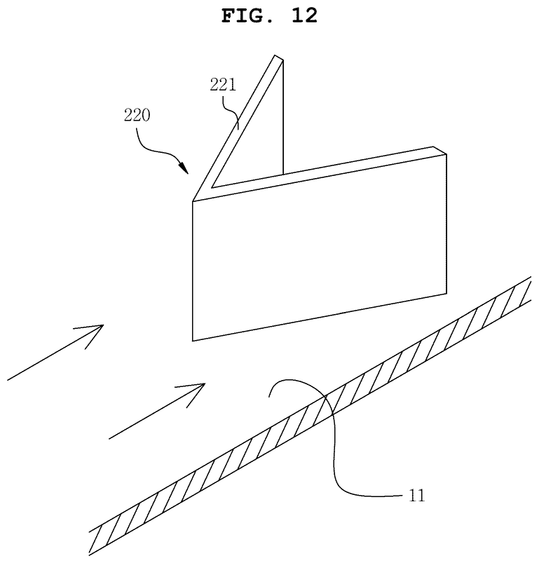

Meanwhile, a heat dissipation member 220 according to another embodiment of the present disclosure is shown in FIG. 12.

Referring to FIG. 12, the heat dissipation member 220 has a plurality of extensions 221 extending in the front-rear direction with respect to the flow direction of growing water in the internal channel.

The extensions 221 are formed such that the front ends are in contact with each other and the rear ends are spaced apart from each other in the flow direction of the growing water in the supply pipe 11 and the spaced distance increases toward the rear from the front end to be able to reduce interference with flow of the growing water passing through the supply pipe 11. That is, it is preferable that the extensions 221 are formed to have a V-shape.

In this case, it is preferable that the insertion holes of the heat dissipation members 220, though not shown, are formed in a V-shape to correspond to the extensions 221 and the heat dissipation fins 211 are also formed in a V-shape to correspond to the insertion holes.

The heat dissipation member 220 having the configuration described above has an advantage that it is possible to reduce interference with flow of the growing water and the heat dissipation efficiency is improved due to an increase of the contact area with plants.

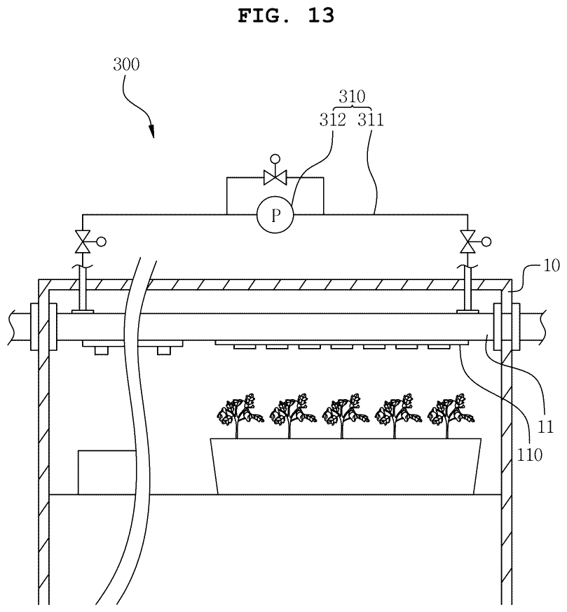

Meanwhile, a plant factory lighting system 300 according to another embodiment of the present disclosure is shown in FIG. 13.

Referring to the figure, the plant factory lighting system 300 includes: a circulator 310 installed at the supply pipe 11 to be able to circulate the growing water remaining in the supply pipe 11 when growing water is not supplied to plants; a temperature sensor (not shown) installed in the supply pipe 11 at a position adjacent to the heat dissipation members 212 to be able to measure the temperature of plants around the heat dissipation members 212; and a circulation controller (not shown) operating the circulator to be able to circulate the growing water remaining in the supply pipe 11 when the temperature of the plants around the heat dissipation members 212 is over a preset limit temperature on the basis of measurement information provided from the temperature sensor.

The circulator 310 includes a circulation pipe 311 connected at a first end to the front end of the supply pipe 11 and connected at a second end to the rear end of the supply pipe 11, and a circulation pump 312 installed at the circulation pipe 311 and circulating the growing water in the supply pipe 11 through the circulation pipe 311.

The temperature sensor is installed in the supply pipe 11 at a position adjacent to the heat dissipation members 212 and measures the temperature of plants around the heat dissipation members 212. Many temperature sensors are installed adjacent to the heat dissipation members 212, respectively, and are temperature measurement sensors that are generally used in the related art to measure surrounding temperature, so they are not described in detail.

When the temperature of plants around the heat dissipation members 212 is over a preset limit temperature on the basis of measurement information provided from the temperature sensor, the circulation controller operates the circulation pump 512 of the circulator 310 to be able to circulate the growing water remaining in the supply pipe 11. In this case, it is preferable that the circulation controller operates the circulation pump 312 only when the supply unit of the growing water supplier stops supplying growing water to the supply pipe 11.

The plant factory lighting system 300 having the configuration described above circulates growing water by operating the circulator 310 when the growing water is overheated by the heat dissipation unit 210, thereby being able to improve the heat dissipation efficiency by the heat dissipation unit 210.

The description of the proposed embodiments is provided to enable those skilled in the art to use or achieve the present disclosure. Various modifications of the embodiments would be apparent to those skilled in the art, and general principles defined herein may be applied to other embodiments without departing from the scope of the present disclosure. Therefore, the present disclosure is not limited to the embodiments proposed herein and should be construed in the widest range that is consistent with the principles proposed herein and new characteristics.

What is claimed is:

1. A plant factory lighting system comprising:
a substrate;
a lighting unit that is mounted on the substrate and includes many LED groups generating light of different wavebands;
a first switch that enables a worker to input a first operation signal for operation of the LED groups through a touch for operation;
a second switch unit that has a lever to be able to be operated by the worker, and includes a toggle switch formed such that that the lever is set any one position of a plurality of setting positions or a neutral position by operation of the worker and a signal generator generating a second operation signal such that the LED groups are operated in different operation patterns in accordance with the position of the lever set by the worker; and
a control module that controls the lighting unit in accordance with the first operation signal or the second operation signal, controls operation of the LED groups to correspond to a first operation signal that is provided from the first switch unit when the lever of the toggle switch is set at the neutral position, and controls operation of the LED groups to correspond to a second signal that is provided from the second switch unit when the lever of the toggle switch is set at the setting positions.

2. The plant factory lighting system of claim 1, wherein the first switch unit includes:
an on/off power touch pad that the worker can touch for operation;
a pattern storage that stores many light emission patterns about operation of the LED groups; and
a pattern setter that generates the first operation signal that the LED groups are operated in any one of the light emission patterns stored in the storage, and generates the first operation signal such that light emission patterns, which are applied to the LED groups of the light emission patterns, are sequentially changed in accordance with a preset operation order when a touch by the worker is input on the on/off power touch pad.

3. The plant factory lighting system of claim 1, wherein the lighting unit is manufactured by doping UV-a LED and BLU LED chips with phosphor to emit light of many wavebands.

4. The plant factory lighting system of claim 3, wherein the lighting unit includes:
a first LED group that emits light having a center waveband of 380 nm by 25% to 35% of the entire photon quantity, emits light of a waveband of 380 nm to 450 nm by 5% to 15% of the entire photon quantity, and emits light of a waveband of 600 nm to 700 nm by the other of the entire photon quantity;
a second LED group that emits light having a center waveband of 380 nm by 15% to 25% of the entire photon quantity, emits light of a waveband of 380 nm to 500 nm by 15% to 25% of the entire photon quantity, and emits light of a waveband of 600 nm to 800 nm by the other of the entire photon quantity; and
a third LED group that emits light of a waveband of 600 nm to 700 nm by 60% to 70% of the entire photon quantity.

5. The plant factory lighting system of claim 1, wherein the substrate is installed in an internal space of a plant cultivation device in which many plants are grown, and
the plant factory lighting system further comprises:
a measurement sensor installed on the substrate and measuring concentration of oxygen or carbon dioxide in the internal space;
a determination module determining a growth state of plants that are grown in the internal space on the basis of information measured by the measurement sensor; and
a recommendation unit providing the worker with information about the waveband of light corresponding to a growth state of plants on the basis of determination information provided from the determination module.

6. The plant factory lighting system of claim 1, wherein the substrate is installed at a supply pipe provided in an internal space of a plant cultivation device to be able to supply growing water to plants that are grown in the internal space; and
the plant factory lighting system further comprises a heat dissipation unit provided at the substrate to be able to dissipation heat, which is generated at the lighting unit, to growing water flowing through the supply pipe so that the lighting unit can be cooled.

7. The plant factory lighting system of claim 6, wherein the heat dissipation unit includes:
at least one heat dissipation fin that is installed on the substrate facing the supply pipe and protruding toward the supply pipe so that heat transferring through the substrate transfers; and
a heat dissipation member that is formed at the supply pipe facing the substrate such that an end is inserted in an internal channel of the supply pipe, through which the growing water flows, and has a insertion hole such that the heat dissipation fin can be inserted, and
the insertion hole is formed with a predetermined depth in the supply pipe from an outer surface of the heat dissipation member, which faces the substrate, such that the heat dissipation fin can be inserted in the supply pipe.

8. The plant factory lighting system of claim 7, wherein the heat dissipation member has a plurality of extensions extending in a front-rear direction with reference to a flow direction of growing water in the internal channel, and
the extensions are formed such that front ends are in contact with each other, rear ends are spaced apart from each other, and a spaced distance increases toward a rear from a front end to be able to reduce interference with flow of growing water passing through the supply pipe.

9. The plant factory lighting system of claim 7, further comprising:
a circulator that is installed at the supply pipe to be able to circulate growing water remaining in the supply pipe when the growing water is not supplied to the plants;
a temperature sensor that is installed in the supply pipe at a position adjacent to the heat dissipation member to be able to measure temperature of growing water around the heat dissipation member; and
a circulation controller that operates the circulator to be able to circulate the growing water remaining in the supply pipe when temperature of growing water around the heat dissipation member is over a preset limit temperature on the basis of measurement information that is provided from temperature sensor.
